(19) United States
(12) Patent Application Publication
(10) Pub. No.: US 2021/0395056 A1
(43) Pub. Date: Dec. 23, 2021

(54) HYDRAULIC LIFTING DEVICE FOR A CHASSIS OF A MOBILE DEVICE, CHASSIS AND MOBILE DEVICE

(71) Applicant: HAWE Hydraulik SE, Aschheim (DE)

(72) Inventor: Sven Müller, Rohr In Niederbayern (DE)

(21) Appl. No.: 17/353,258

(22) Filed: Jun. 21, 2021

(30) Foreign Application Priority Data
Jun. 23, 2020 (DE) 10 2020 207 787.8

(51) Int. Cl. B66F 3/30; B66F 3/46

(52) U.S. Cl. CPC B66F 3/30; B66F 3/46

(57) ABSTRACT

A hydraulic lifting device for a chassis of a mobile device has a valve block, a pump, a tank, a first cylinder device and a second cylinder device. The first cylinder device and the second cylinder device can be selectively pressurized by the pump or connected to tank via the valve block. The first cylinder device is connected to the pump via at least one primary non-return valve disposed in the valve block. The second cylinder device is connected to the pump via at least one secondary non-return valve disposed in the valve block. The valve block has at least one pressure accumulator downstream of the at least one secondary non-return valve in the flow direction from the pump to the second cylinder device. Furthermore, a chassis with such a lifting device and to a mobile device with a chassis is provided.

### CROSS-REFERENCE TO RELATED APPLICATIONS

This application claims priority to German Application No. 10 2020 207 787.8, filed Jun. 23, 2020, of which is hereby incorporated by reference in its entirety.

### FIELD OF THE INVENTION

The present invention relates to a hydraulic lifting device for a chassis of a mobile device, a chassis with such a hydraulic lifting device and a mobile device with a chassis according to the invention. The mobile device may in particular be a medical device.

### BACKGROUND OF THE INVENTION

Such hydraulic lifting devices or chassis are known from the prior art and are used in particular in the medical field for mobile medical equipment, for example in mobile operating robots or mobile operating tables. These hydraulic lifting devices, also known as “floor lock” systems, are used to firmly fix, support and level the mobile medical equipment during use, regardless of the ground.

To make this possible, such hydraulic lifting devices regularly have a valve block, a pump, a tank and several cylinder devices with several cylinders. The cylinder devices can be pressurised by the pump via the valve block, so that they extend and are supported on the ground and thus the chassis of the medical device is lifted or jacked up from the ground. This causes the castors or wheels hinged to the chassis to lose contact with the ground, so that unintentional movement of the chassis is prevented. Furthermore, solutions are also known in which the cylinder devices are supported on the ground with a certain force without the chassis being lifted. Nevertheless, this force is sufficient to prevent unwanted movements and to level the chassis at the same time.

The pump is usually designed to be operated manually, for example by hand or foot. However, it is possible that the pump is driven, for example by a power unit. For lowering the chassis, the valve block has a lowering device, usually also manually operated, which connects the cylinder devices to the tank. When the lowering device is actuated, the hydraulic fluid is pressed out of the cylinder devices to the tank by the dead weight of the mobile medical device until the castors or wheels of the chassis come into contact with the ground again. Springs are usually provided in the cylinders of the cylinder devices, which also support the return during lowering.

In order to keep the medical device in the lifted position, the valve block has non-return valves in the direction of flow from the pump to the respective cylinder device, as is known, for example, from EP 3 386 458 B1 or DE 10 2012 001 555 A1. A chassis with a hydraulic lifting device is known from EP 3 386 458 B1, which has a first cylinder device with two primary cylinders and a second cylinder device with two secondary cylinders. The two primary cylinders are connected to the pump via a common first non-return valve, whereby the two secondary cylinders are each connected to the pump via a secondary non-return valve and are thus protected.

Particularly high demands are placed on these non-return valves with regard to leak tightness over time. This is because it is essential to prevent the medical device from lowering noticeably or even completely during what may be a prolonged treatment. In the case of protection via only one non-return valve per cylinder device or cylinder, this cannot be reliably guaranteed due to manufacturing tolerances or dirt particles in the hydraulic fluid. Due to the resulting small leakage flows through the respective non-return valve, the medical device may be lowered unintentionally over time. This is a particular problem if a relatively low (holding) pressure is applied downstream of the non-return valve.

This problem could be largely solved by redundant protection. However, this noticeably increases the space required for the valve block. This in turn has an impact on the weight and cost of the hydraulic lifting device.

### SUMMARY OF THE INVENTION

With this in mind, it is the object of the present invention to provide a hydraulic lifting device for a chassis of a mobile device in which unintentional lowering over time can be effectively prevented without causing a noticeable increase in size of the valve block of the hydraulic lifting device.

The problem is solved with a hydraulic lifting device for a chassis of a mobile device as disclosed herein. Preferable further embodiments are also disclosed.

The hydraulic lifting device according to the invention has a first cylinder device and a second cylinder device. The first cylinder device is connected to the pump via at least one primary non-return valve disposed in the valve block and the second cylinder device is connected to the pump via at least one secondary non-return valve disposed in the valve block. The invention is distinguished from the prior art in that the valve block has at least one pressure accumulator in the flow direction from the pump to the second cylinder device downstream of the at least one secondary non-return valve.

This ensures that a gradual pressure loss at the secondary non-return valve over time does not lead to an unwanted lowering by retracting the second cylinder device. Furthermore, such a pressure accumulator can also be easily integrated into the valve block, so that the overall installation space of the valve block is not noticeably increased. This in turn has a favorable effect on the costs and the weight of the valve block. In addition, the pressure accumulator can also be used to compensate for pressure losses that do not necessarily occur at the secondary non-return valve. It is also conceivable that a micro-leakage at the drainage device leads to a creeping pressure loss.

Preferably, the first cylinder device can be pressurised via a first pressure reducing valve and the second cylinder device can be pressurised via a second pressure reducing valve, wherein an output pressure of the first pressure reducing valve is different from an output pressure of the second pressure reducing valve. In particular, it is preferable if the output pressure at the first pressure reducing valve is greater than the output pressure at the second pressure reducing valve. In this regard, it is particularly preferable if the pressure accumulator has a volume of no more than 1 cm³, in particular no more than 0.5 cm³.

The pressure reducing valves can be used to apply pressure hierarchically to the first and second cylinder devices by first extending the first cylinder device or its cylinders when pressure is applied by the pump, for example up to a predefined stop. The second cylinder device is only adjusted here insofar as the output pressure acting on the second cylinder device is lower than the output pressure acting on the first cylinder device. As soon as the first cylinder device is fully extended, a holding pressure can be built up at the second cylinder device by further actuation of the pump, which is, however, limited by the output pressure set at the second pressure reducing valve. Consequently, the holding pressure at the first cylinder device is greater than the holding pressure at the second cylinder device, so that a creeping pressure loss at the secondary non-return valve is particularly critical. This possible pressure loss is compensated by the pressure accumulator. In order not to undermine the functionality described above with the hierarchical pressurisation of the two cylinder devices, it has proven preferable to dispense with a large-volume pressure accumulator and to use a pressure accumulator with a volume of no more than 1 cm³, which completely compensates for the possible leakage volume. Furthermore, such a pressure accumulator is also small and can be integrated directly into the valve block, so that no installation space disadvantages arise.

Preferably, the second cylinder device comprises two secondary cylinders and the valve block comprises two secondary non-return valves, each of the two secondary cylinders being connected to the pump via a secondary non-return valve. In this regard, it is preferable if the valve block has a second identical pressure accumulator, wherein one pressure accumulator each is disposed upstream of the respective secondary non-return valve in the flow direction from the pump to the respective secondary cylinder. This makes it possible to prevent a retracting at both secondary cylinders due to a pressure loss at the respective secondary non-return valve.

Preferably, the at least one pressure accumulator is a spring accumulator or the pressure accumulators are spring accumulators. Preferably, the at least one pressure accumulator has a spring and a piston, the piston being disposed movably against a force of the spring in a receiving bore of the valve block. This allows a particularly compact design that can be integrated directly into the valve block.

Preferably, the pressure accumulator has a sealing cap that is fixed to the valve block and closes the receiving bore. In this way, the installation space of the valve block can be further reduced.

Furthermore, the problem is solved with a chassis according to claim 9, which comprises a hydraulic lifting device according to the invention as described above. The problem is further solved with a mobile device according to claim 10, which comprises such a chassis. The mobile device may in particular be a mobile medical device.

### BRIEF DESCRIPTION OF THE DRAWINGS

The invention is explained in more detail below referring to an exemplary embodiment shown in the figures. The figures show schematically:

FIG. 1 is a hydraulic circuit diagram of a hydraulic lifting device according to the invention;

FIG. 2 is an exploded view of a valve block of a hydraulic lifting device according to the invention;

FIG. 3 is a side view of the valve block shown in FIG. 2 with a built-in pressure accumulator; and

FIG. 4 is a sectional view along section line A-A through the valve block shown in FIG. 3.

### DETAILED DESCRIPTION OF THE INVENTION

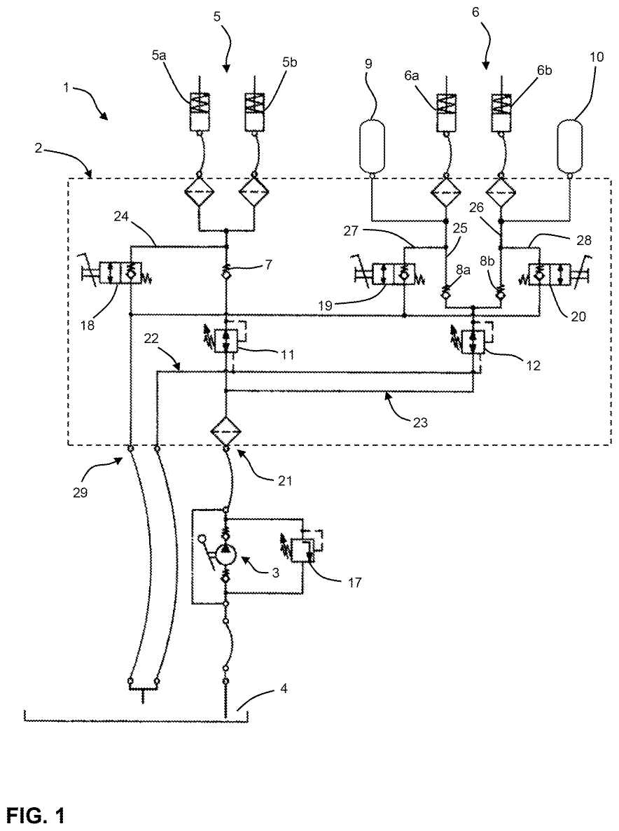

FIG. 1 shows a hydraulic circuit diagram of a hydraulic lifting device 1 according to the invention for a mobile medical device, for example a surgical robot. The hydraulic lifting device 1 has a valve block 2, a manually operated pump 3, a tank 4, a first cylinder device 5 and a second cylinder device 6. The valve block 2 comprises a first and a second pressure accumulator 9, 10. The first cylinder device 5 comprises two primary cylinders 5a, 5b and the second cylinder device 6 comprises two secondary cylinders 6a, 6b. In the embodiment shown, the primary cylinders 5a, 5b and the secondary cylinders 6a, 6b are configured as single-acting hydraulic cylinders with return springs.

The pump 3 is connected to the tank 4 and the valve block is connected to the pump 3 via a first connection 21. When the pump 3 is actuated, hydraulic fluid is pumped from the tank 4 via the first connection 21 to the valve block 2. In the valve block 2, a first line arrangement 22 supplies the first cylinder device 5 and a second line arrangement 23 supplies the second cylinder device 6 with pressure. Viewed in the direction of flow from the pump 3 to the first cylinder device 5, a first pressure-reducing valve 22, a primary non-return valve 7 and a drain line 24 with a manually operable drain valve 18 are disposed in the first line arrangement 22. A single primary non-return valve 7 is thus disposed in the first line arrangement 22, which secures the two primary cylinders 5a, 5b of the first cylinder device 5.

A second pressure reducing valve 12 is disposed in the second line arrangement 23 in the direction of flow from the pump 3 to the second cylinder device 6. Downstream of the second pressure reducing valve 12, the second line arrangement 23 branches into a first branch 25 and a second branch 26. In each branch 25, 26 a secondary non-return valve 8a, 8b and a drain line 27, 28 with a manually operated drain valve 19, 20 are disposed downstream of the second pressure reducing valve 12. One of the pressure accumulators 9, 10 is disposed downstream of each of the secondary non-return valves 8a, 8b. In this exemplary embodiment, the pressure accumulators 9, 10 each have a volume of 0.5 cm³. In the second line arrangement 23, one of the secondary non-return valve 8a, 8b each secures one of the two secondary cylinders 6a, 6b of the second cylinder device 6.

The first pressure reducing valve 11 is set to a higher output pressure than the second pressure reducing valve 12. This allows hierarchical pressurization of the first cylinder device 5 and the second cylinder device 6. When the pump 3 is actuated, hydraulic fluid is pumped from the tank 4 into the valve block 2 and there via the first line arrangement 22 to the first cylinder device 5 and via the second line arrangement 23 to the second cylinder device 6. A uniform extension of the primary cylinders 5a, 5b and the secondary cylinders 6a, 6b takes place until the two primary cylinders 5a, 5b (or support feet or the like attached thereto) contact the ground. Due to the higher output pressure of the first pressure reducing valve 11, the primary cylinders 5a, 5b are then pressurized and the secondary cylinders 6a, 6b are readjusted or retraced due to the lower output pressure at the second pressure reducing valve 12. As soon as the primary cylinders 5a, 5b are extended to their mechanically limited maximum position, further actuation of the pump 3 generates a certain holding pressure in the secondary cylinders 6a, 6b, which, however, corresponds at most to the output pressure of the second pressure reducing valve 12. Preferably, the output pressure of the second pressure reducing valve 12 is set to the weight of the mobile medical device.

When the secondary cylinders 6a, 6b are extended or when the first and second branches 25, 26 are pressurized respectively, the two pressure accumulators 9, 10 are charged. As soon as the maximum pressure downstream of the secondary non-return valves 8a, 8b is reached, the mobile medical device is fully jacked up or lifted. The holding pressure acting on the second cylinder device 6 is lower than the holding pressure acting on the first cylinder device 5, so that a possible creeping pressure loss at the secondary non-return valves 8a, 8b is compensated via the pressure accumulators 9, 10. The volume of 0.5 cm³ per pressure accumulator 9, 10 described above is sufficient for this. A possible creeping pressure loss at the primary non-return valve 7 is not critical due to the considerably higher holding pressure. However, it is conceivable that a pressure accumulator acting on the first line arrangement 22 downstream of the primary non-return valve 7 is also used. This could provide further protection for the first cylinder device 5. It is also conceivable that only one pressure accumulator 9, 10 is used for both secondary cylinders 6a, 6b.

Furthermore, a pressure relief valve 17 bridging the pump 3 is provided. When the primary cylinders 5a, 5b and the secondary cylinders 6a, 6b are fully extended and the pump 3 continues to be actuated, the pressure relief valve 17 opens and hydraulic fluid is pumped in circuit.

To lower the mobile medical device, the drain valves 18, 19, 20 are actuated so that the first line arrangement 22 and the second line arrangement 23 are connected to the tank 4 via the respective drain line 24, 27, 28 and a second connection 29. It is conceivable that the drain valves 18, 19, 20 are operated manually together and thus form a drainage device.

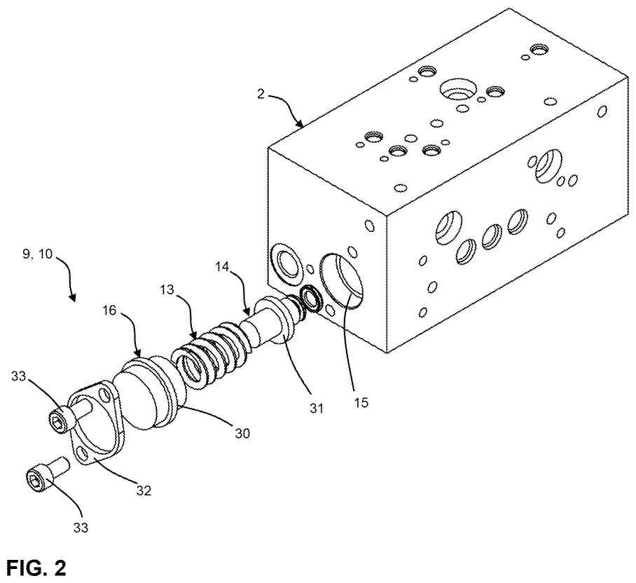

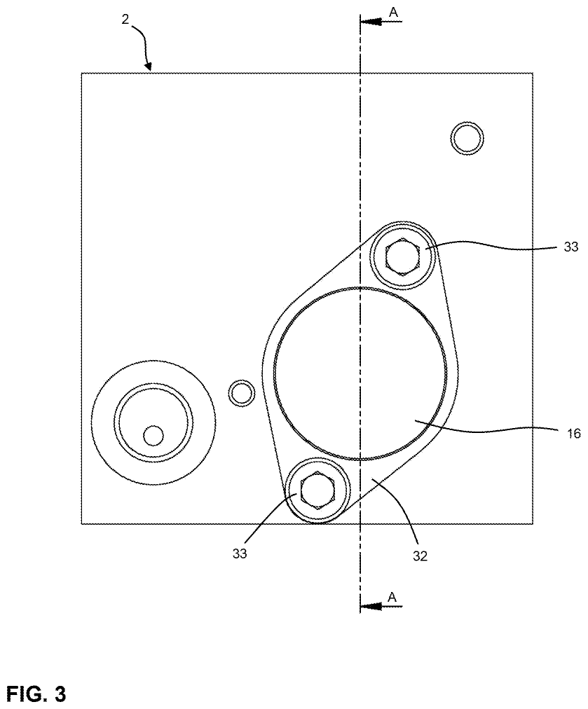

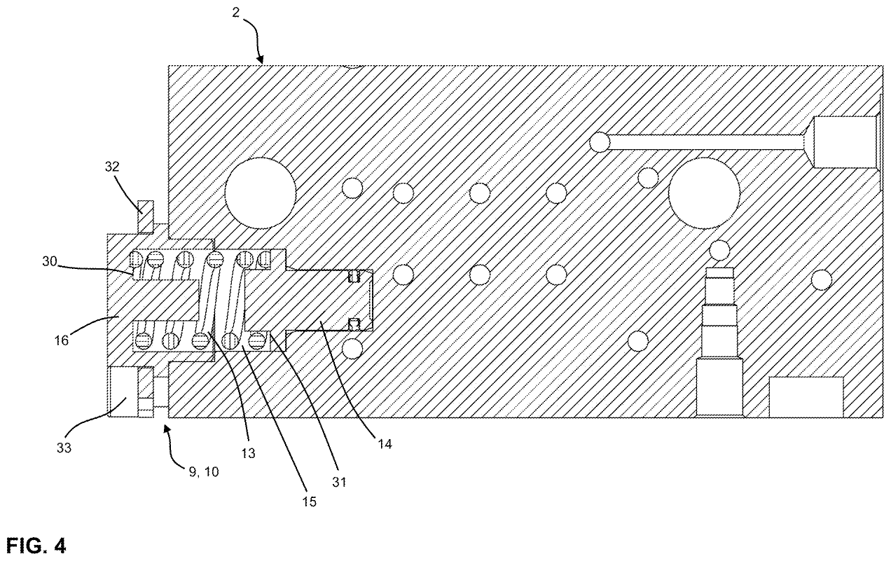

In the following, the construction of the pressure accumulators 9, 10 is described with reference to FIGS. 2 to 4. For reasons of clarity, only one of the two pressure accumulators 9, 10 is described.

The pressure accumulator 9, 10 is configured as a spring accumulator and has a spring 13, a piston 14 and a sealing cap 16 The spring 13 is supported on the one hand on a first receptacle 30 of the sealing cap and on the other hand on a second receptacle 31 of the piston 14. The sealing cap 16 is fixed to the valve block 2 by means of a clip 32 and two screws 33 in such a way that the piston 14 is movable in a receiving bore 15 of the valve block 2 against a force of the spring 13. As shown, the sealing cap 16 closes the receiving bore 15.

When the second line arrangement 23 is pressurized, the piston 14 is moved against the force of the spring 13 in the direction of the sealing cap 16 to such an extent that a storage volume of 0.5 cm³ is provided in the maximum position of the piston 14. It has been shown that a storage volume of at most 1 cm³ is sufficient to compensate for a creeping pressure loss at the secondary non-return valves 8a, 8b. It has also been shown that such a storage volume still allows for the hierarchical pressurization described above, as an excessively large storage volume would necessitate a higher output pressure at the second pressure reducing valve 12.

### LIST OF REFERENCE SIGNS

1 hydraulic lifting device
2 valve block
3 pump
4 tank
5 first cylinder device
5a, 5b primary cylinder
6 second cylinder device
6a, 6b secondary cylinder
7 primary non-return valve
8a, 8b secondary non-return valve
9 pressure accumulator
10 pressure accumulator
11 first pressure reducing valve
12 second pressure reducing valve
13 spring
14 piston
15 receiving bore
16 cap
17 pressure relief valve
18 drain valve
19 drain valve
20 drain valve
21 first connection
22 first line arrangement
23 second line arrangement
24 drain line
25 first branch
26 second branch
27 drain line
28 drain line
29 Second connection
30 First receptacle
31 second receptacle
32 clip
33 screw

1. A hydraulic lifting device for a chassis of a mobile device, comprising:
a valve block;
a pump;
a tank;
a first cylinder device; and
a second cylinder device;
wherein:
the first cylinder device and the second cylinder device can be selectively pressurized by the pump or connected to the tank via the valve block;
the first cylinder device is connected to the pump via at least one primary non-return valve disposed in the valve block;
the second cylinder device is connected to the pump via at least one secondary non-return valve disposed in the valve block; and
the valve block has at least one pressure accumulator downstream of the at least one secondary non-return valve in the direction of flow from the pump to the second cylinder device.

2. The hydraulic lifting device according to claim 1, further comprising:
a first pressure-reducing valve and a second pressure-reducing valve;
wherein:
the first cylinder device can be pressurized via the first pressure-reducing valve; and
the second cylinder device can be pressurized via the second pressure-reducing valve; and
an output pressure of the first pressure-reducing valve is different from an output pressure of the second pressure-reducing valve.

3. The hydraulic lifting device according to claim 2, wherein the output pressure of the first pressure-reducing valve is greater than the output pressure of the second pressure-reducing valve.

4. The hydraulic lifting device according to claim 1, wherein the at least one pressure accumulator has a volume of at most 1 cm³.

5. The hydraulic lifting device according to claim 4, wherein the at least one pressure accumulator has a volume of at most 0.5 cm³.

6. The hydraulic lifting device according to claim 1, wherein the second cylinder device comprises two secondary cylinders and the at least one secondary non-return valve of the valve block comprises two secondary non-return valves, each of the two secondary cylinders being connected to the pump via one of the secondary non-return valves.

7. The hydraulic lifting device according to claim 6, wherein the valve block comprises a second identical pressure accumulator, one of the pressure accumulator each being disposed upstream of the respective secondary non-return valve in the direction of flow from the pump to the respective secondary cylinder .

8. The hydraulic lifting device according to claim 1, wherein the at least one pressure accumulator is a spring accumulator.

9. The hydraulic lifting device according to claim 8, wherein the spring accumulator comprises a spring and a piston, the piston being disposed movably against a force of the spring in a receiving bore of the valve block.

10. The hydraulic lifting device according to claim 9, wherein the spring accumulator comprises a sealing cap fixed to the valve block and closing the receiving bore.

11. A chassis of a mobile device comprising a hydraulic lifting device according to claim 1.

12. A mobile device comprising a chassis according to claim 11.

13. The mobile device according to claim 12, wherein the mobile device is a mobile medical device
